(19) United States
(12) Patent Application Publication
(10) Pub. No.: US 2008/0098103 A1
(43) Pub. Date: Apr. 24, 2008

(54) Methods and Apparatus for Tunneling Legacy Network Management Messages through SNMP (Simple Network Management Protocol)

(76) Inventor: Mathi Packiam, Southbury, CT (US)

Correspondence Address: GORDON & JACOBSON, P.C., 60 LONG RIDGE ROAD, SUITE 407, STAMFORD, CT, 06902, US

(21) Appl. No.: 11/620,099

(22) Filed: Jan. 5, 2007

Related U.S. Application Data
(60) Provisional application No. 60/829,962, filed on Oct. 18, 2006.

(51) Int. Cl. G06F 15/173

(52) U.S. Cl. 709/223

(57) ABSTRACT

Software and/or hardware modules enable secure management of legacy network products. In an illustrated example, if a network device is managed using unsecure SNMPv1 or SNMPv2, the invention acts as an intermediary and applies SNMPv3 security, without the need to migrate the existing network management code to SNMPv3. The invention can be delivered in the form of a stand-alone box, or be integrated into existing products.

### CROSS-REFERENCE TO RELATED APPLICATIONS

This application claims benefits from U.S. Provisional Patent Application No. 60/829,962, filed Oct. 18, 2006, the contents of which are hereby incorporated herein by reference.

### INCORPORATION BY REFERENCE

All of the IETF (internet engineering task force) RFC (request for comments) documents cited in this application are hereby incorporated herein by reference.

### BACKGROUND OF THE INVENTION

1. Field of the Invention

This invention relates broadly to computer and communications networks. More particularly, this invention relates to network management messages exchanged between network management stations and managed network devices.

2. State of the Art

Communications and computer networks require a management station to communicate with network devices such as routers, switches, printers, hosts, etc. The management station is responsible for configuring the network devices and determining the status of network devices. Management messages are typically in the form of a request and a response. The management station sends a request to the network device and the device responds to the management station. However, it is also common to provide for unsolicited messages from network devices to the management station. These unsolicited messages, known as trap messages, are used to indicate the occurrence of some undesirable event, e.g. device failure, printer out of paper, etc.

Prior to 1988, there existed many different (often proprietary) network management protocols which defined the way in which management stations and managed devices communicated. With the introduction of the internet protocol (IP) came the development of the “simple network management protocol” (SNMP). The Simple Network Management Protocol (SNMP) is an application layer protocol that facilitates the exchange of management information between network devices. It is part of the Transmission Control Protocol/Internet Protocol (TCP/IP) protocol suite. SNMP enables network administrators to manage network performance, find and solve network problems, and plan for network growth. There are currently four versions of SNMP. SNMPv1 was always considered an interim protocol because, among other reasons, it lacked adequate security. SNMPv1 is defined in IETF RFC 1065-1067. SNMPv2, introduced in 1993, included a controversial security system, better performance and manager to manager communications. SNMPv2 is defined in IETF RFC 1441-1452. The security system was controversial because many thought that it was unduly complex. As a result, it was not widely accepted and a modified version, known as SNMPv2c (IETF RFC 1901-1908), was introduced with a simpler security system. In late 2002, SNMPv3 (IETF RFC 3411-3418) emerged as the current standard. SNMPv3 has a security system similar to SNMPv2 and has other improvements.

An SNMP-managed network consists of three key components: managed network devices, agents, and network management systems. A managed network device is a network node that contains an SNMP agent and that resides on a managed network. Managed network devices collect and store management information and make this information available to network management stations using SNMP. Managed network devices, sometimes called network elements, can be routers and access servers, switches and bridges, hubs, computer hosts, or printers. An agent is a network-management software module that resides in a network managed device. An agent has local knowledge of management information and translates that information into a form compatible with SNMP. A network management station executes applications that monitor and control managed network devices. One or more network management stations must exist on any managed network.

Managed network devices are monitored and controlled using four basic SNMP commands: read, write, trap, and traversal operations.

Read (or get) commands are used by network management stations to monitor managed network devices whereby a network management station directly examines different variables that are maintained by a managed network device.

Write (or set) commands are used by network management stations to control managed network devices whereby a network management station changes the values of variables stored within a managed network device.

Trap commands are used by managed network devices to asynchronously report events to network management systems. When certain types of events occur, a managed network device sends a trap command to a network management station.

Traversal operations (e.g., get-next commands) are used by network management stations to determine which variables a managed network device supports and to sequentially gather information in variable tables, such as a routing table.

SNMP was designed for an expanding network and it adapts to new network equipment through the use of management information bases (MIBs). The MIB is a collection of information that is organized hierarchically. MIBS are comprised of managed objects that are identified by object identifiers. A managed object (sometimes called a MIB object or an object) is one of any number of specific characteristics of a managed network device. Managed objects are comprised of one or more object instances, which are essentially variables. Two types of managed objects exist: scalar and tabular. Scalar objects define a single object instance. Tabular objects define multiple related object instances that are grouped in MIB tables.

An object identifier (or object ID) is a numeric identifier, specified as a sequence of integers, that uniquely identifies a managed object in the MIB hierarchy. The MIB hierarchy can be depicted as a tree with a nameless root, the levels of which are assigned by different organizations. The top-level MIB object IDs belong to different standards organizations, while lower-level object IDs are allocated by associated organizations. Vendors can define private branches that include managed objects for their own products.

SNMP commands utilize variable bindings as part of their message format. A variable binding includes two fields: an object identifier (sometimes referred to as an object name) and an object value. The object identifier refers to a particular managed object stored as a part of a MIB. The object value is the value of the managed object. For any type of get request command, the object value is null (since the get request command is requesting a value).

SNMPv1 specified five PDUs (protocol data units): GET REQUEST (aka GET), used to retrieve management information, GET NEXT REQUEST (aka GET NEXT), used to iteratively retrieve information, GET RESPONSE (aka RESPONSE), used by the agent to respond, SET REQUEST (aka SET), used to set a parameter, and TRAP (aka a notification), used by the agent to report an alert. Later versions of SNMP added the PDUs GETBULK REQUEST, a faster iterative retrieval, and INFORM which is like TRAP but requires the manager to reply with a GET RESPONSE.

An SNMPv1 message contains two parts: a header and the PDU. The header contains the version number and the community name. The community name defines a group of network managers which exist within the same administrative domain. The GET, GET NEXT, RESPONSE, and SET PDUs all contain the same fields which are illustrated in Table A below.

TABLE A

| | | | | | | |
|---|---|---|---|---|---|---|
| PDU | Request | Error | Error | Object 1 | Object 2 | Object x |
| Type | ID | Status | Index | Value 1 | Value 2 | Value x |

The “PDU Type” field specifies GET, GET NEXT, RESPONSE, or SET. The “Request ID” field is used to associate responses with requests. The “Error Status” and “Error Index” fields are only used in the RESPONSE PDU. The “Object and Value” fields 1 through x are referred to as “variable bindings” and they serve as the data field of the PDU. Each variable binding associates a particular object with its current value, except in the GET and GET NEXT PDUs where the value is ignored. The TRAP PDU is illustrated in Table B below.

TABLE B

| | | | | | | | |
|---|---|---|---|---|---|---|---|
| Enterprise | Agent | Generic | Specific | Time | Object 1 | Object 2 | Object x |
| | Address | Trap | Trap | Stamp | Value 1 | Value 2 | Value x |
| | | Type | Code | | | | |

The “Enterprise” field identifies the type of managed object generating the trap. The “Agent Address” field provides the address of the managed object generating the trap. The “Generic Trap Type” field indicates one of a number of trap types. The “Specific Trap Code” field indicates one of a number of specific trap codes. The “Time Stamp” field indicates the amount of elapsed time between the last network reinitialization and the generation of the trap. The variable bindings field “Object 1 Value 1” through “Object x Value x” each associate a particular object with its current value.

An SNMPv2 message also contains two parts: the message header and the PDU. The message header is the same as in SNMPv1. The PDUs for GET, GET NEXT, INFORM, RESPONSE, SET, and TRAP are the same as illustrated above in Table A. The PDU for GETBULK is illustrated in Table C below.

TABLE C

| | | | | | | |
|---|---|---|---|---|---|---|
| PDU | Request | Non- | Max- | Object 1 | Object 2 | Object |
| Type | ID | repeaters | repetitions | Value 1 | Value 2 | x |
| | | | | | | Value x |

The “PDU Type” field identifies the PDU as a GETBULK operation. The “Request ID” field is used to associate responses with requests. The “Non-repeaters” field specifies the number of object instances in the variable bindings field that should be retrieved no more than once from the beginning of the request. This field is used when some of the instances are scalar objects with only one variable. The “Max-repetitions” field defines the maximum number of times that the variables beyond those specified by the “Non-repeaters” field should be retrieved. The variable bindings field “Object 1 Value 1” through “Object x Value x” each associate a particular object with its current value.

While SNMPv1 and SNMPv2 have many similarities, SNMPv3 changes the message format significantly. The format is illustrated in vertical Table D below.

TABLE D

| Field Number | Field Definition |
|---|---|
| 1 | msgVersion |
| 2 | msgID |
| 3 | msgMaxSize |
| 4 | msgFlags |
| 5 | msgSecurityModel |
| 6 | msgAuthoritativeEngineID |
| 7 | msgAuthoritativeEngineBoots |
| 8 | msgAuthoritativeEngineTime |
| 9 | msgUserName |
| 10 | msgAuthenticationParameters |
| 11 | msgPrivacyParameters |
| 12 | contextEngineID |
| 13 | contextName |
| 14 | PDU |

The “msgVersion” field has the same meaning as the version number in the header of previous versions of SNMP. The “msgID” field is the same as the “Request ID” field in previous versions of SNMP. In SNMPv3 the msgID has a range of 0 through (2³¹−1). The field “msgMaxSize” indicates the maximum size of a message, in octets, supported by the sender of the message, i.e. the maximum size of a message that the sender can accept from another SNMP device. It has a range of 484 through (2³¹−1). The field “msgFlags” is an octet containing three flags in the three least significant bits. The flags are “reportableFlag”, “privFlag”, and “authFlag”. If reportableFlag=1, then a Report PDU must be returned to the sender under those conditions that can cause the generation of a Report PDU; when the flag is zero, a Report PDU may not be sent. The reportableFlag is set to 1 by the sender in all messages containing a request (Get, Set) or an Inform, and set to 0 for messages containing a Response, a Trap, or a Report PDU. The “reportableFlag” field is a secondary aid in determining when to send a Report. The Report PDU is used only in cases in which the PDU portion of the message cannot be decoded (for example, when decryption fails because of an incorrect key). The “privFlag” and “authFlag” fields are set by the sender to indicate the security level that was applied to the message. For privFlag=1, encryption was applied and for privFlag=0, authentication was applied. All combinations are allowed except (privFlag=1 AND authFlag=0); that is, encryption without authentication is not allowed. The field “msgSecurityModel” identifies the security model that was used to prepare the message. It has a range of 0 through (2³¹−1). Reserved values include 1 for SNMPv1, 2 for SNMPv2, and 3 for SNMPv3.

SNMPv3 implements the concept of an authoritative engine. In any message transmission, one of the two entities, transmitter or receiver, is designated as the authoritative SNMP engine, according to a set of rules. The field “msgAuthoritativeEngineID” identifies the authoritative SNMP engine. The field “msgAurthoritativeEngineBoots” is an integer in the range 0 through (2³¹−1) that represents the number of times that this SNMP engine has initialized or reinitialized itself since its initial configuration. The field “msgAuthoritativeEngineTime” is an integer in the 0 through (2³¹−1) range that represents the number of seconds since this authoritative SNMP engine last incremented “msgAurthoritativeEngineBoots”. The field “msgUserName” identifies the user on whose behalf the message is being exchanged. The field “msgAuthenticationParameters” is a parameter used in the DES encryption algorithm. The cipher-block-chaining (CBC) mode of DES is used by SNMPv3. This mode requires that an initial value (IV) be used to start the encryption process. The “msgPrivacyParameters” field in the message header contains a value from which the IV can be derived by both sender and receiver. The fields “contextEngineID” and “contextName” are used to limit access to MIBs.

The Structure of Management Information (SMI) defines the format for defining MIBS that are accessed via the SNMP protocol, the data types of objects, and the format for defining events (called traps in SMIv1 and notifications in SMIv2). There are currently two versions of the SMI, which are SMIv1 (full) and SMIv2 (draft). SMIv1 is defined by RFC 1155, RFC 1212, and RFC 1215. SMIv2 is defined by RFC 1902, RFC 1903, and RFC 1904.

Since the time SNMPv1 was introduced, a very large number of network devices have been developed and deployed in private and public networks. Many of these devices implement obsolete versions of SNMP or non-standard management protocols. Although versions prior to SNMPv3 are considered obsolete, IETF RFC 3584 explains how these different versions can coexist. Although they can coexist, the devices which implement obsolete management protocols can not take advantage of the improved features of the newer protocols, most particularly they cannot provide secure network management as provided in SNMPv3.

It would therefore be desirable to provide an inexpensive means by which legacy network devices and management stations can take advantage of the features of the latest version of SNMP (e.g., the security function that is part of SNMPv3) without the need for expensive software upgrading in each device.

### SUMMARY OF THE INVENTION

It is therefore an object of the invention to provide methods and apparatus by which legacy network equipment can take advantage of the features of a later version of SNMP (e.g., the security function that is part of SNMPv3).

It is another object of the invention to provide methods and apparatus by which legacy network equipment can take advantage of more recent versions of SNMP without altering the legacy equipment.

In accord with these objects, which will be discussed in detail below, the present invention provides two modules: one for the network management stations and the other for managed network devices. The two modules create an SNMP tunnel through which legacy management messages are sent. At the manager tunnel endpoint (MTE), legacy management messages from one or more network management stations are encapsulated into SNMP messages, which are forwarded to a device tunnel endpoint (DTE). At the device tunnel endpoint (DTE), the legacy management message is decapsulated from the SNMP message, and the legacy management message is forwarded to the recipient managed network device. Legacy response messages from the managed network devices are encapsulated at the DTE into SNMP messages, which are forwarded to the MTE. At the MTE, the legacy response message is decapsulated from the SNMP message and forwarded to the recipient network management station. A single MTE may serve several network management stations and a single DTE may serve several managed network devices. A single MTE may communicate with multiple DTEs. Each MTE is configured with i) the IP addresses of the DTEs it will support and ii) the IP addresses of the devices supported by each DTE it will support. If the MTE is situated on an IP host separate from the network management station(s) that it will support, it is also configured with the IP address of such network management station(s). The DTEs are similarly configured.

According to the illustrated embodiment, the MTE and DTE encapsulate SNMPv1 messages into SNMPv3 messages and decapsulate the SNMPv1 messages from such SNMPv3 messages. However, the invention can be applied to encapsulate any legacy management message into any SNMP version message.

According to one aspect of the invention, the DTEs each maintain an MIB specifically structured to carry out the tunneling function of the invention. In particular, the MIB includes tunnel objects and tunnel traps. The tunnel objects include a tunnel trap receiver table, a tunnel command table and a tunnel response table. The tunnel command table and the tunnel response table work together to encapsulate requests and responses. The object ID of the tunnel response table is larger than the object ID of the tunnel command table and there is no MIB element between the tunnel command table and the tunnel response table. These two tables are always empty for the purposes of any GET or SET request and are only used for encapsulating and sending requests and responses. The tunnel traps include a tunnel trap receiver table which is used by the DTE to encapsulate traps. It is empty at all other times.

According to the illustrated embodiment, when the MTE receives a legacy message from a network management station, the source and destination addresses are extracted from the IP header. Using the MTE configuration, the DTE serving the destination address is determined. If no DTE is found, the packet is quietly dropped, i.e. dropped but no error message is generated. A sequence ID is incremented. An “augmented” PDU is built by concatenating the legacy PDU with the extracted source address and original UDP header. The augmented PDU together with the manager address, device address and sequence ID are encapsulated in the object portion of a single variable binding (with a null value) of an SNMPv3 GET NEXT PDU. The PDU is then given an SNMPv3 header, UDP header and IP header directing it to the DTE determined from the MTE configuration. The DTE receives the SNMPv3 message, extracts the augmented PDU from the object part of the variable binding, rebuilds the legacy message, and adds a UDP header and the IP header from the DTE configuration which sends it to its destination managed network device. The DTE also begins preparing for a response by writing the ultimate source address, ultimate destination address, and sequence ID to the tunnel response table.

When the DTE receives a legacy response message from a managed network device, it extracts the manager address (destination) and the device address (source) from the IP header. It extracts the request ID from the PDU. It builds an augmented PDU by concatenating the legacy PDU with the original UDP header and device address. The augmented PDU together with the manager address, device address and sequence ID are encapsulated in the object portion of a single variable binding (with a null value) of an SNMPv3 RESPONSE PDU. The PDU is then given an SNMPv3 header, UDP header and IP header directing it to the MTE determined from information saved in the tunnel response table (in the previous step). The MTE receives the SNMPv3 message, extracts the augmented PDU from the object part of the variable binding, rebuilds the legacy message, and adds a UDP header and the IP header from the MTE configuration which sends it to its destination network management station.

When the DTE receives a legacy TRAP message from a managed device, it extracts the manager address (destination) and the device address (source) from the IP header. It finds the MTE address corresponding to the manager address from the DTE configuration and if no MTE is found, the packet is quietly dropped. It builds an augmented PDU by concatenating the legacy PDU with the original UDP header and device address. The trap manager address, Object ID from the tunnel trap receiver table, and the tunnel trap payload are encapsulated in the object portion of a single variable binding of an SNMPv3 TRAP PDU. The augmented PDU is placed in the value portion of the variable binding. The PDU is then given an SNMPv3 header, UDP header and IP header directing it to the MTE determined from the DTE configuration. The MTE receives the SNMPv3 message, extracts the augmented PDU from the value part of the variable binding, rebuilds the legacy message, and adds a UDP header and the IP header from the MTE configuration which sends it to its destination.

Additional objects and advantages of the invention will become apparent to those skilled in the art upon reference to the detailed description taken in conjunction with the provided figures.

### BRIEF DESCRIPTION OF THE DRAWINGS

FIG. 1 is a schematic block diagram of two management stations coupled to four network devices through the tunneling apparatus of the invention;

FIG. 2 is a schematic illustration of the tunneling MIB according to the invention;

FIG. 3 is a schematic block diagram of the MTE according to the invention;

FIG. 4 is a schematic block diagram of the DTE according to the invention;

FIG. 5 is an illustration of how the MTE encapsulates an SNMPv1 request from a management station into an SNMPv3 message for the DTE;

FIG. 6 is an illustration of how the DTE decapsulates an SNMPv1 message for a network device from an SNMPv3 message;

FIG. 7 is an illustration of how the DTE encapsulates an SNMPv1 response from a network device into an SNMPv3 response for the MTE;

FIG. 8 is an illustration of how the MTE decapsulates an SNMPv1 response from a an SNMPv3 response for the management station;

FIG. 8a is an illustration of how the MTE “to manager packet receptor” handles the packet created in FIG. 8;

FIG. 9 is an illustration of how the DTE encapsulates an SNMPv1 trap from a network device into an SNMPv3 trap for the MTE;

FIG. 10 is an illustration of how the MTE decapsulates an SNMPv1 trap from a an SNMPv3 trap for the management station; and

FIG. 11 is a schematic block diagram of a management station coupled to a network device through the tunneling apparatus according to an alternate embodiment of the invention.

### DETAILED DESCRIPTION

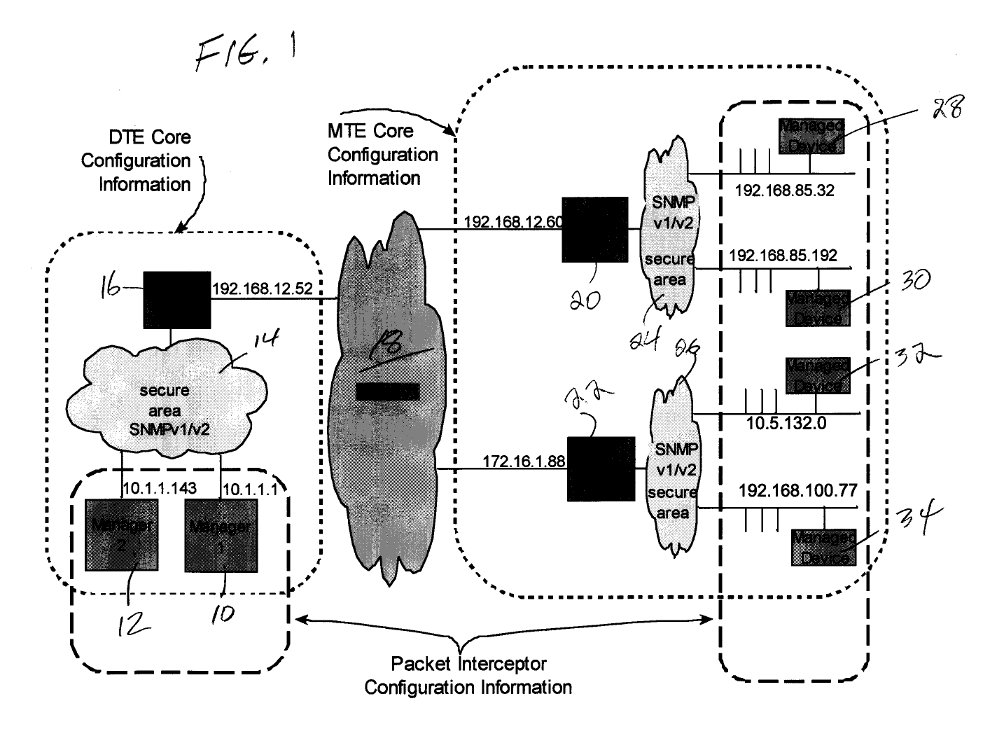

Turning now to FIG. 1, according to the illustrated embodiment, a pair of network management stations 10, 12 are coupled to a secure (local area) network 14, also referred to as a first intermediate network. A manager tunnel endpoint (MTE) 16, also referred to as a first intermediate network interface, is coupled to the network 14 and to a wide area network 18, also referred to as a communication network. Two device tunnel endpoints (DTEs) 20, 22 are coupled to the wide area network 18. Each DTE 20, 22, also referred to as a second intermediate network interface, is coupled to a respective secure (local area) network 24, 26, also referred to as second intermediate networks. Each local area network 24, 26 is respectively coupled to two managed network devices 28, 30, 32, 34.

The MTE 16 contains core configuration information about the addresses of the DTEs and the managed network devices. Exemplary MTE core configuration information is shown in Table 1.

TABLE 1

| | | | Device |
|---|---|---|---|
| Cluster | DTE Address | Device Net | NetMask |
| 1 | 192.168.12.60 | 192.168.85.32 | 255.255.255.240 |
| 2 | 192.168.12.60 | 192.168.85.192 | 255.255.255.240 |
| 3 | 172.16.1.88 | 10.5.132.0 | 255.255.255.0 |
| 4 | 172.16.1.88 | 192.168.100.77 | 255.255.255.255 |

Table 1 associates the addresses of the managed network devices 28, 30, 32, and 34 with the addresses of the DTEs 20, 22 that serve them. If the MTE is not on the same IP host as the managers, it is also provided with manager packet receptor information. Table 2 is exemplary of manager packet receptor information.

TABLE 2

| | Manager | | Device |
|---|---|---|---|
| Cluster | Address | Device Net | NetMask |
| 1 | 10.1.1.1 | 192.168.85.32 | 255.255.255.240 |
| 2 | 10.1.1.1 | 192.168.85.192 | 255.255.255.240 |
| 3 | 10.1.1.1 | 10.5.132.0 | 255.255.255.0 |
| 4 | 10.1.1.143 | 192.168.100.77 | 255.255.255.255 |

Table 2 associates the addresses of the managed network devices 28, 30, 32, and 34 with the address of the network management stations 10, 12 that manage them.

The DTEs 20, 22 each contain core configuration information about the addresses of the MTE and the network management stations. Exemplary DTE core configuration information is shown in Table 3.

TABLE 3

| | | Manager | Manager |
|---|---|---|---|
| Cluster | MTE Address | Net | NetMask |
| 1 | 192.168.12.52 | 10.1.1.1 | 255.255.255.255 |
| 2 | 192.168.12.52 | 10.1.1.143 | 255.255.255.255 |

Table 3 associates the addresses of the network management stations 10, 12 with the address of the MTE 16 which serves them. If a DTE is not on the same IP host as the managed network devices it serves, it is also provided with device packet receptor information. Table 4 is exemplary of device packet receptor information.

TABLE 4

| | Manager | | Device |
|---|---|---|---|
| Cluster | Address | Device Net | NetMask |
| 1 | 10.1.1.1 | 192.168.85.32 | 255.255.255.240 |
| 2 | 10.1.1.1 | 192.168.85.192 | 255.255.255.240 |

Table 4 associates the addresses of managed network devices 28, 30 with the address of the network management station 10 that manages them.

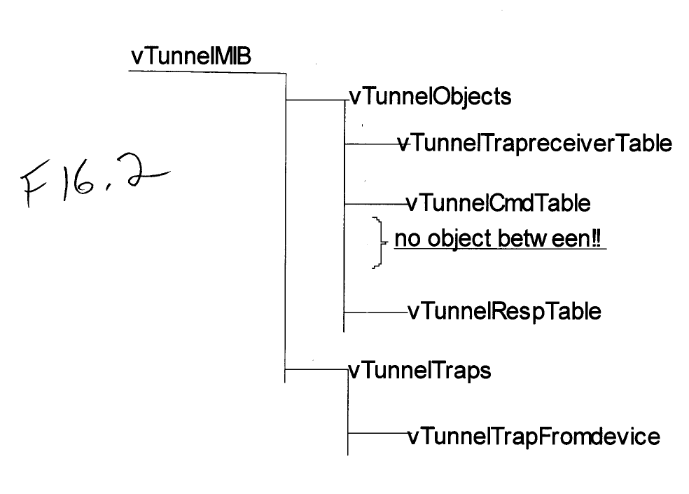

Turning now to FIG. 2, the DTEs each maintain an MIB specifically structured to carry out the tunneling function of the invention and the MTEs are all aware of this MIB. In particular, the MIB includes tunnel objects and tunnel traps. The tunnel objects include a tunnel trap receiver table, a tunnel command table and a tunnel response table. The tunnel command table and the tunnel response table work together to encapsulate requests and responses. The object ID of the tunnel response table is larger than the object ID of the tunnel command table and there is no MIB element between the tunnel command table and the tunnel response table. These two tables (tunnel command and tunnel response) are always empty for the purposes of any GET or SET request and are only used for encapsulating and sending requests and responses. The MIB also includes a tunnel trap receiver table which is used by the DTE to encapsulate traps. It is empty at all other times.

An exemplary tunnel command table according to the invention is described in Table 5.

TABLE 5

| # | Name | Index? | Type | Description |
|---|---|---|---|---|
| 1 | managerAddress | yes | ipAddress | Manager that sourced the original |
| | | | | SNMPv1 request PDU. |
| 2 | deviceAddress | yes | ipAddress | Device that the SNMPv1 request |
| | | | | PDU was directed to. |
| 3 | sequenceID | yes | unsigned32 | generated by the MTE to help |
| | | | | DTE's response generation. |
| 4 | cmd1 | yes | octet-string | The first ‘n1’ octets of ‘augmented’ |
| | | | | SNMPv1 request PDU. |
| 5 | cmd2 | yes | octet-string | The next ‘n2’ octets of |
| | | | | ‘augmented’ SNMPv1 request |
| | | | | PDU. |
| 6 | cmd3 | yes | octet-string | The next ‘n3’ octets of |
| | | | | ‘augmented’ SNMPv1 request |
| | | | | PDU. |
| 7 | cmd4 | yes | octet-string | The next ‘n4’ octets of |
| | | | | ‘augmented’ SNMPv1 request |
| | | | | PDU. |
| 8 | cmd5 | yes | octet-string | The last ‘n5’ octets of |
| | | | | ‘augmented’ SNMPv1 request |
| | | | | PDU. |
| 9 | status | no | integer | Read-only. The only ‘accessible’ element. |

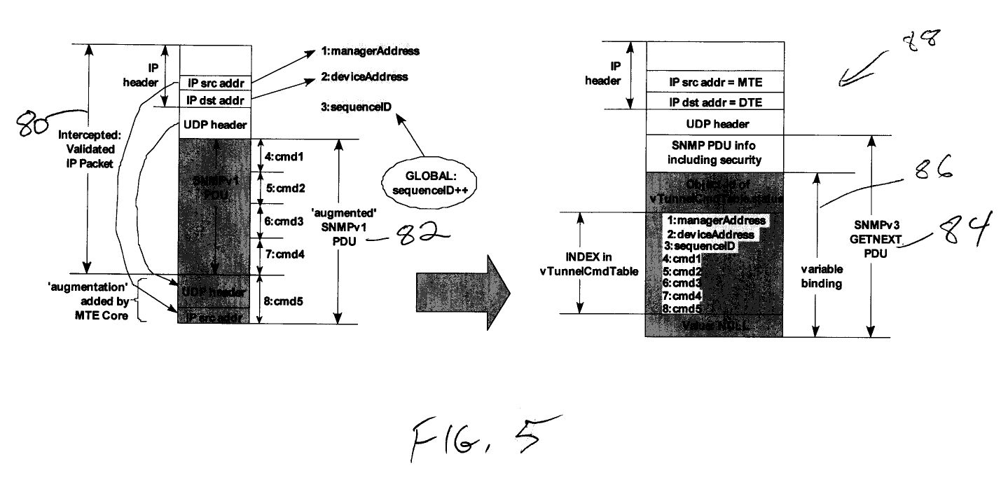

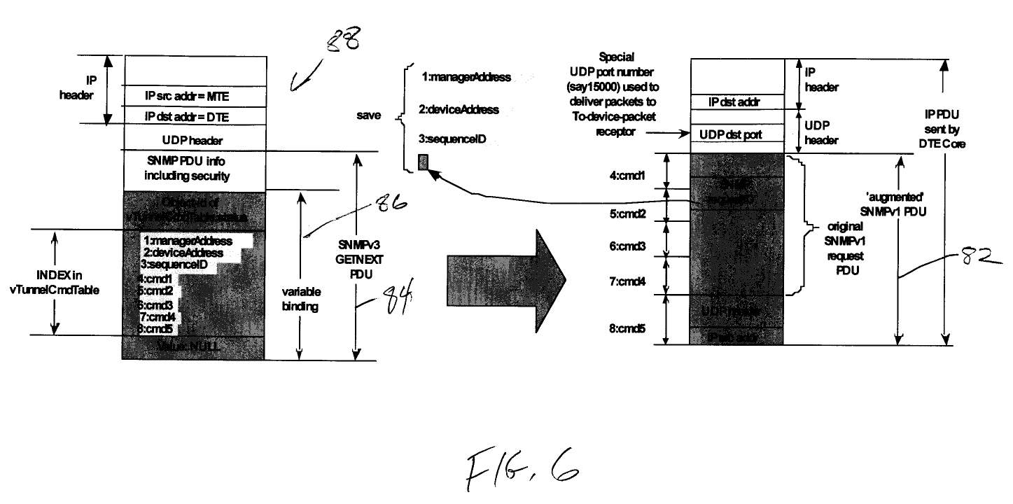

The rows of Table 5 describe the columns of the tunnel command table. As stated above, the MIB resides with the DTE and tunnel command table is filled by the DTE with information received from the MTE. The first column of the tunnel command table is the IP address of the network management station that sent the management request. The second column of the tunnel command table is the IP address of the managed network device to which the request is directed. The sequence ID is generated by the MTE. It works like a request ID and is used in the third column of the tunnel command table to match SNMPv3 requests with responses. Columns four through eight of the tunnel command table contain a request PDU segmented into a number of segments. The number of segments and the relative sizes of the segments are arbitrary. In the illustrative embodiment described herein, five segments are used for programming convenience. More particularly, with 5 segments, a 1 Kbyte PDU is split into pieces that are each less than 256 bytes. Management message PDUs are also referred to as application data. The PDU is “augmented” as described below with reference to FIGS. 5 and 6. The last column of the tunnel command table is an SNMP “status integer read only”. Thus, the tunnel command table will look something like table 5A. The column labeled “PDU parts 1-5” is actually five columns. The first eight columns are considered SNMP “indexes”. The ninth column read only status integer is also defined by SNMP.

TABLE 5A

| | | | | |
|---|---|---|---|---|
| 10.1.1.1 | 192.168.85.32 | “32-bit number” | “PDU parts1–5” | RO |

A tunnel response table according to the invention is similar to the tunnel command table described above and is described as Table 6 below.

TABLE 6

| # | Name | Index? | Type | Description |
|---|---|---|---|---|
| 1 | managerAddress | yes | ipAddress | Manager to which the MTE should |
| | | | | send the SNMPv1 response PDU |
| 2 | deviceAddress | yes | ipAddress | Device that sourced the SNMPv1 |
| | | | | response PDU. |
| 3 | Sequence ID | yes | unsigned32 | copied from the SNMPv3 request PDU: |
| | | | | vTunnelCmdTable.sequenceID |
| 4 | response | no | octet-string | read-only: ‘augmented’ SNMPv1 |
| | | | | response PDU. |

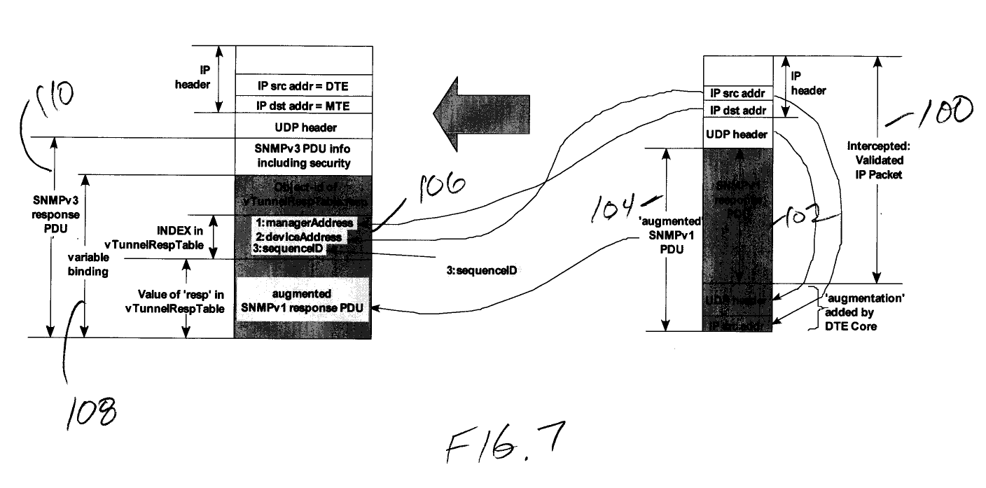

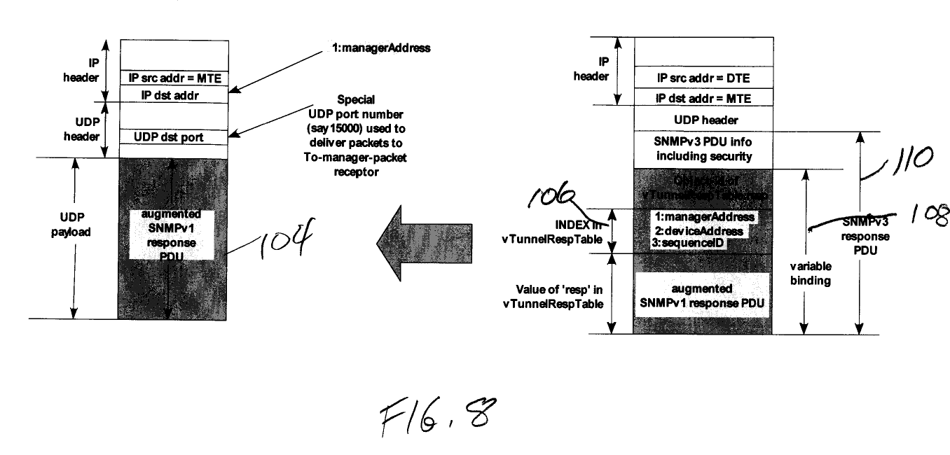

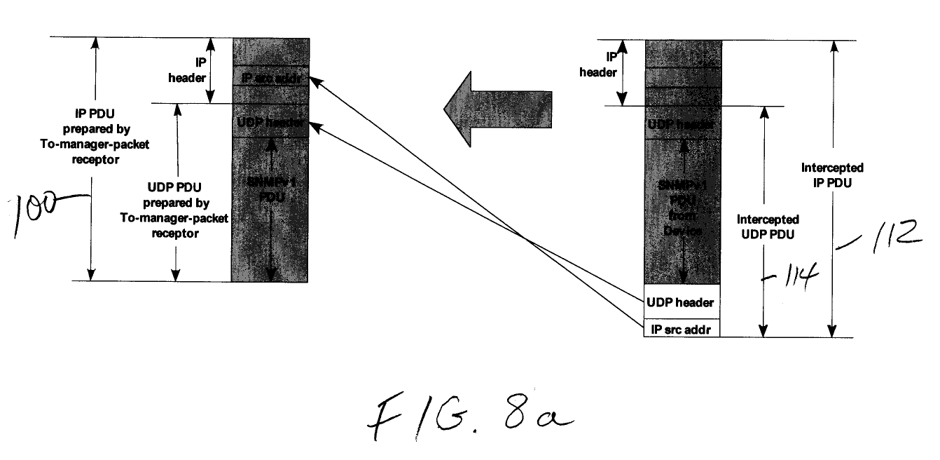

The first three indexes specify the reverse flow addressing and the sequence ID that was copied from the request sequence ID in the tunnel command table. The last entry is an SNMP RESPONSE, augmented as described below with reference to FIGS. 7 and 8. The tunnel response table is always empty for purposes of direct GET and SET operations. The table is only used by the DTE to encapsulate an SNMPv1 response into an SNMPv3 response.

The tunnel objects of the tunnel MIB (FIG. 2) also include a tunnel trap receiver table. An exemplary tunnel trap receiver table according to the invention is described in Table 7.

TABLE 7

| # | Name | Index? | Type | description |
|---|---|---|---|---|
| 1 | trapManagerAddress | yes | ipAddress | Manager to which the |
| | | | | MTE should send this |
| | | | | SNMPv1 trap PDU |
| 2 | vTunnelTrapPayload | no | octet- | Accessible-for-notify: |
| | | | string | ‘augmented’ SNMPv1 |
| | | | | trap PDU. |

The tunnel trap receiver table enables a DTE to encapsulate SNMPv1 traps in SNMPv3 traps and send them to the MTE. In the DTE, the table is empty except when generating a trap. When the DTE receives an SNMPv1 trap from a device, it adds a new row in the table, and generates an SNMPv3 trap and sends to the MTE. Immediately following that, the DTE deletes the row from the table.

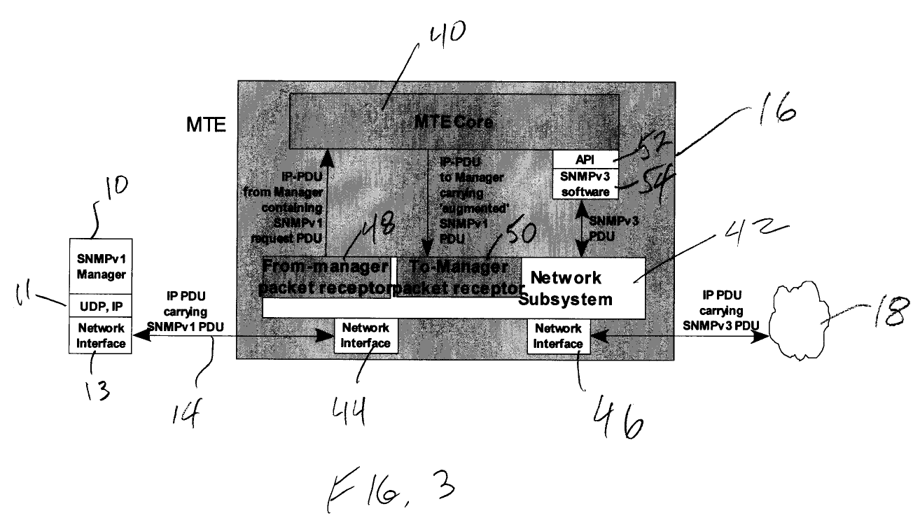

Turning now to FIG. 3, additional details regarding the MTE 16 are shown. For purposes of illustration the MTE will be shown encapsulating and decapsulating SNMPv1 messages into and out of SNMPv3 messages. However, the invention can be applied to encapsulate any legacy management message into any SNMP version message. According to the illustrated embodiment, the MTE includes an MTE core 40 and a network subsystem 42. The network subsystem 42 couples the MTE to network 14 via a network interface 44 and to network 18 via a network interface 46. The only connection that the network 14 has to the network 18 is through the MTE. Therefore, the network subsystem 42 is designed to allow non-management packets to pass through the MTE unmodified.

FIG. 3 illustrates the network management station 10 associated with a network interface 13 with UDP and IP layers 11. Outgoing SNMPv1 packets from the network management station 10 are intercepted by the network subsystem 42 via a “from manager packet receptor” 48 and sent to the MTE core 40. The “from manager packet receptor” tests the packet to determine: whether the UDP is addressed to port 161 (a default SNMP port on IPv4 interfaces), whether the packet contains an SNMPv1 PDU, whether it is a GET, GETNEXT, or SET request, whether its source is a network management station supported by the MTE and whether its destination is a managed network device supported by the MTE. If all of these requirements are met, the packet is sent to the MTE core 40. If any one of the requirements is not met, the packet is sent to the network subsystem 42 without any processing by the MTE core.

When the MTE core 40 receives an SNMPv1 message from the “from manager packet receptor” 48 it processes it as described below with reference to FIG. 5 and uses the API 52 of SNMPv3 software 54 to prepare an SNMPv3 message which is passed to the network subsystem for transport to the DTE. The SNMPv3 software intercepts SNMPv3 messages entering the network subsystem 42 from the network interface 46, and passes them to the MTE core 40 for processing as described below with reference to FIGS. 8 and 8a. The result of such processing is an augmented SNMPv1 message which is passed to the network subsystem 42 via the “to manager packet receptor” 50 for transport to the manager.

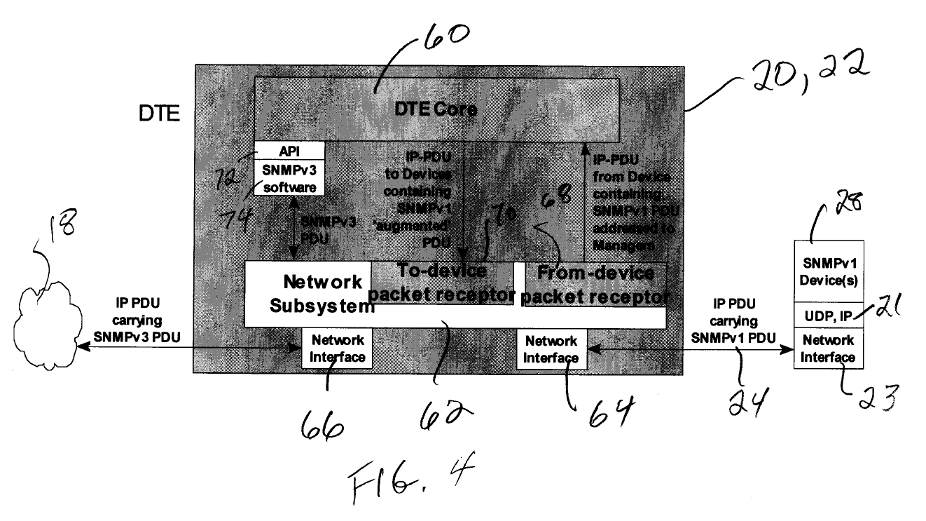

Turning now to FIG. 4, the DTE includes a DTE core 60 and a network subsystem 62. The network subsystem 62 couples the DTE to network 24 via a network interface 64 and to network 18 via a network interface 66. The only connection that the network 24 has to the network 18 is through the DTE. Therefore, the network subsystem 62 is designed to allow non-management packets to pass through the DTE unmodified.

FIG. 4 illustrates the managed network device 28 associated with a network interface 23 with UDP and IP layers 21. Outgoing SNMPv1 packets from the device 28 are intercepted by the network subsystem 62 via a “from device packet receptor” 68 and sent to the DTE core 60. The “from device packet receptor” tests the packet to determine: whether the UDP is addressed to port 161 or 162 (default SNMP ports on IPv4 interfaces) whether the packet contains an SNMPv1 PDU, whether it is a RESPONSE or TRAP, whether its source is a managed network device supported by the DTE, and whether its destination is a network management station supported by the DTE. If all of these requirements are met, the packet is sent to the DTE core 60. If any one of the requirements is not met, the packet is sent to the network interface 66 without any processing by the DTE.

When the DTE core 60 receives an SNMPv1 message from the “from device packet receptor” 68 it processes it as described below with reference to FIG. 7 and uses the API 72 of SNMPv3 software 74 to prepare an SNMPv3 message which is passed to the network subsystem 62 for transport to the MTE. The SNMPv3 software intercepts SNMPv3 messages entering the network subsystem from the network interface 66, and passes them to the DTE core 60 for processing as described below with reference to FIG. 6. The result of such processing is an augmented SNMPv1 message which is passed to the network subsystem 62 via the “to device packet receptor” 70 for transport to the device.

FIG. 5 illustrates the processing of an augmented SNMPv1 packet by the MTE core of FIG. 3. The left side of FIG. 5 shows the intercepted and validated IP packet 80 which contains an SNMPv1 PDU, a UDP header, and an IP header which contains the IP address of the source and the IP address of the destination. The MTE core strips off the headers and creates an “augmented” SNMPv1 PDU 82 by appending the UDP header and the IP address of the source to the end of the of the SNMPv1 PDU. Using the SNMPv3 software (54 in FIG. 3), the MTE core creates an SNMPv3 GETNEXT PDU 84.

The MTE uses information extracted from the IP packet 80 to fill the object portion of a single variable binding 86 in the GETNEXT PDU 84 according to the structure of the tunnel command table (Table 5). This information includes the SNMP object ID of the tunnel command table status element, followed by the IP address of the network management station, the IP address of the managed network device, the sequence ID (which was incremented by the MTE from a global variable), and the augmented SNMPv1 PDU 82 split into a number of segments. The number of segments and the relative sizes of the segments are arbitrary. In the illustrative embodiment described herein, five segments are used for programming convenience with the SNMPv1 PDU divided into 4 equally sized segments and the fifth segment carrying the augmentation information (UDP header and IP service address). The value portion of the variable binding is set to NULL. The GETNEXT PDU is appended to a UDP header and an IP header which includes the address of the MTE and the address of the DTE (obtained from the MTE core configuration). If the core configuration does not contain an appropriate DTE address, the packet is quietly dropped. When a DTE address is found, the resulting packet 88 is sent through the network subsystem 42 (FIG. 3), the network interface 46, and out to the network 18.

Referring now to FIGS. 4 and 6, the SNMPv3 software 74 intercepts SNMPv3 requests received at network interface 66 and network subsystem 62 and forwards the received SNMPv3 requests to the DTE core 60 via API 72. When the DTE core 60 receives the SNMPv3 request that was sent to it by the MTE, it strips off the headers, and processes the SNMPv3 GETNEXT PDU according to the tunnel command table (Table 5) in the tunnel MIB (FIG. 2). The status object of the SNMPv3 GETNEXT PDU is null and thus is not relevant. The IP address of the network management station, the IP address of the managed network device, and the sequence ID are saved for use in preparing the SNMPv3 response. The augmented SNMPv1 PDU 82 is extracted from the object identifier of the variable binding 86 of the SNMPv3 GETNEXT PDU and the request sequence ID is extracted and saved in association with the manager address and device address in the tunnel response table.

An SNMPv1 packet is created with the augmented PDU 82 together with an IP header and a UDP destination port (e.g. 15000). This packet is sent to the network subsystem 62 where it is intercepted by the “to device packet receptor” 70 which rebuilds the original SNMPv1 request and sends it to the destination managed network device 28.

Packets arriving from the managed network device 28 are intercepted by the “from device packet receptor” 68 if they meet all of the following requirements: are addressed to UDP port 161 or 162, contain an SNMPv1 PDU, are a RESPONSE or a TRAP, are from a managed network device supported by the DTE and are addressed to a network management station supported by the DTE. If any one of these criteria is not met, the packet is sent to network subsystem 62. Otherwise they are sent to the DTE core 60.

Turning now to FIGS. 4 and 7, when the DTE core 60 receives an SNMPv1 packet 100 from a managed network device, it extracts the IP address of the network management station (the destination IP address) and the IP address of the managed network device (the source IP address) from the IP header. It extracts the request ID from the PDU 102. It builds an augmented PDU 104 by concatenating the legacy PDU with the original UDP header and device address. The augmented PDU 104 including the manager address, device address and sequence ID are encapsulated in the object portion 106 of a single variable binding 108 (with a null value) of an SNMPv3 RESPONSE PDU 110. The PDU is then given an SNMPv3 header, UDP header and IP header directing it to the MTE determined from the DTE configuration.

Referring now to FIGS. 3 and 8, the MTE core receives the SNMPv3 message, extracts the augmented PDU 104 from the object part of the variable binding 108, rebuilds the SNMPv1 message, and adds a UDP header and the IP header from the MTE configuration which sends it to its destination. The “to manager packet receptor” 48 intercepts the packet if it has the correct UDP port address (e.g., 15000). The “to manager packet receptor” 48 rebuilds the original SNMPv1 message as shown in FIG. 8a by moving the IP header and UDP header from the end of the packet to the beginning of the packet.

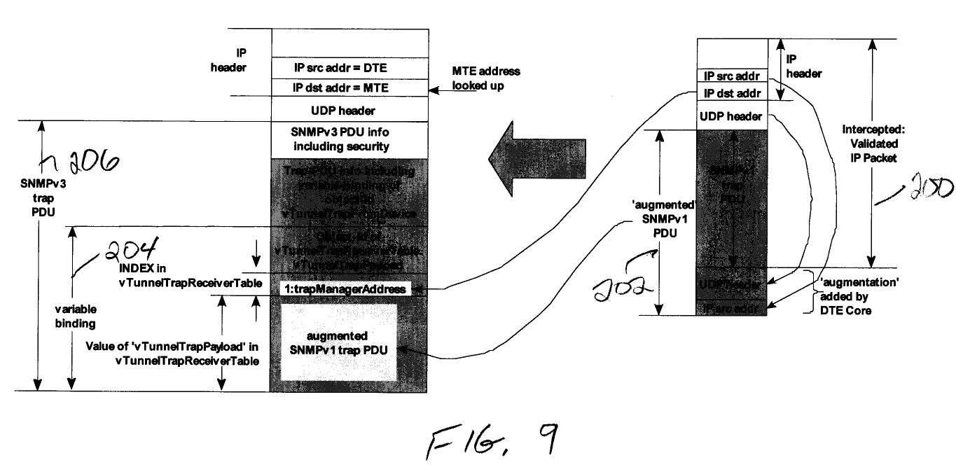

Turning now to FIGS. 4 and 9, when the “from device packet receptor” 68 intercepts an SNMPv1 TRAP 200 it sends it to the DTE core 60 for processing. When the DTE core receives the TRAP message, it extracts the IP address of the network management station (the destination IP address) and the IP address of the managed network device (the source IP address) from the IP header. It finds the MTE address corresponding to the network management station address from the DTE configuration. If no MTE address is found, the packet is quietly dropped. It builds an augmented SNMPv1 PDU 202 by concatenating the SNMPv1 PDU with the original UDP header and device address. The Object ID from the tunnel trap receiver table (Table 7), the trap manager address, and the augmented SNMPv1 PDU 202 are encapsulated into a single variable binding 204 of an SNMPv3 TRAP PDU 206. The augmented SNMPv1 PDU 202 is placed in the value portion of the variable binding 204. The SNMPv3 PDU is then given an SNMPv3 header, UDP header and IP header directing it to the MTE determined from the DTE configuration.

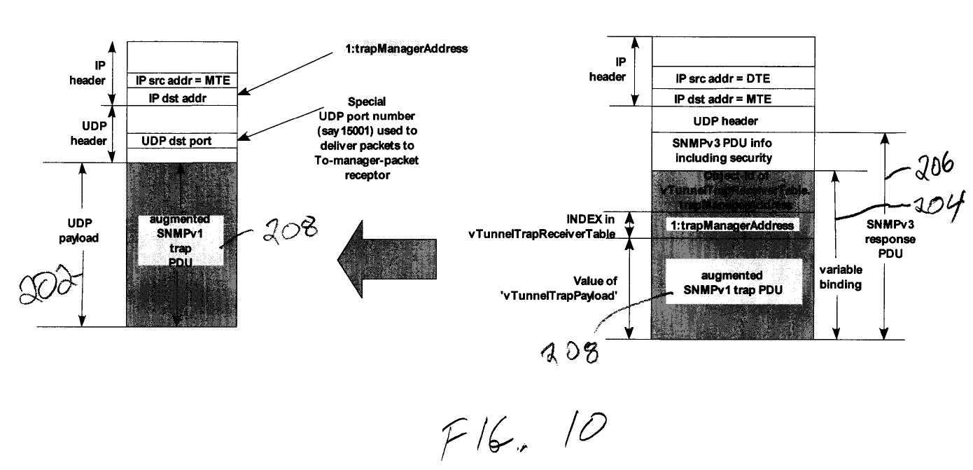

Referring now to FIGS. 3 and 10, the MTE core receives the SNMPv3 message, extracts the augmented SNMPv1 PDU 208 from the value part of the variable binding 204, and adds a UDP header and the IP header. The UDP header sends it to the “to manager packet receptor” 50 which performs the operations described above with reference to FIG. 8a and thus reconstructs the original SNMPv1 TRAP PDU.

Those skilled in the art will appreciate that the augmentation of the legacy PDUs is needed because of the division between user space and kernel space in the operating system which is running the communications software. It will be thus appreciated that the augmentation of the legacy PDUs can be eliminated if the software is arranged differently.

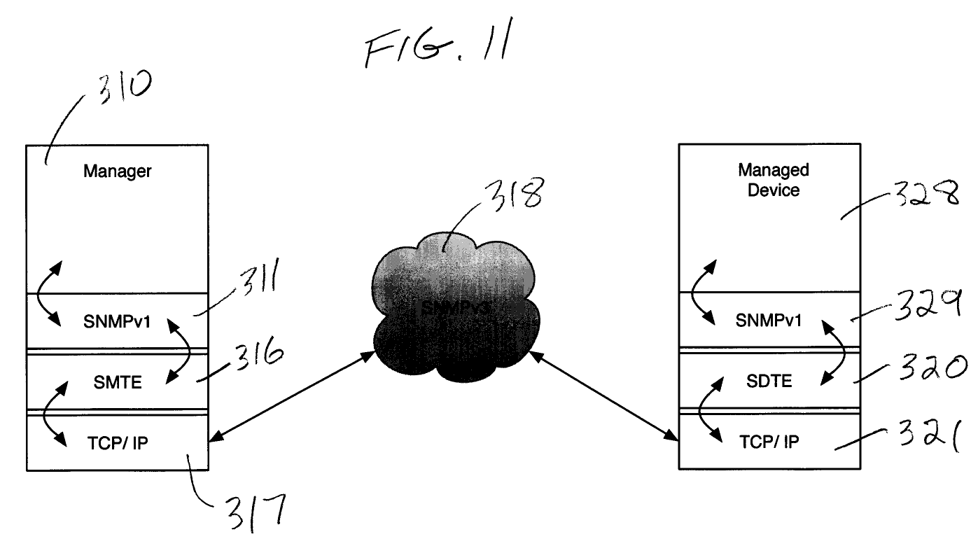

Further, those skilled in the art will appreciate that the port monitoring function of the “packet receptors” as described above can be eliminated if the invention is implemented as a “shim”. FIG. 11 shows an alternate embodiment of the invention wherein the functionality of the MTE as described above is realized as a software shim SMTE 316 and the functionality of the DTE is realized as a software shim SDTE 320. Here it can be seen that the network management station 310 includes SNMPv1 functionality 311 which would normally communicate directly with TCP/IP functionality 317. According to this embodiment of the invention, the Shim MTE (SMTE) 316 is interposed between the SNMPv1 functionality 311 and the TCP/IP functionality 317 and is interfaced to the SNMPv1 functionality in a manner that invokes the SMTE processing without requiring any port monitoring function. Similarly, the managed network device 328 includes SNMPv1 functionality 329 which would normally communicate directly with TCP/IP functionality 321. According to this embodiment of the invention, the Shim DTE (SDTE) 320 is interposed between the SNMPv1 functionality 329 and the TCP/IP functionality 321 and is interfaced to the SNMPv1 functionality in a manner that invokes the SDTE processing without requiring any port monitoring function. It will be appreciated, however, that the SMTE equipped managers can operate with DTE equipped managed devices and SDTE equipped devices can operate with MTE equipped managers.

There have been described and illustrated herein embodiments of methods and apparatus for tunneling legacy network management messages through SNMP. While particular embodiments of the invention have been described, it is not intended that the invention be limited thereto, as it is intended that the invention be as broad in scope as the art will allow and that the specification be read likewise. Thus, while particular IP ports and IP addresses have been disclosed, it will be appreciated that other IP port numbers and IP addresses might be used as well. In addition, while the MTE and DTE have been disclosed in block diagrams of key components, it will be understood the functions of the MTE and DTE could be conceptualized in different blocks so long as the same functions are accomplished. For example, and not by way of limitation, the DTE core function can be implemented as an SNMP subagent, or it could be integrated into a master agent. Also, the MTE could be integrated into a network diagnostic software toolset. Once a DTE has been deployed in the field either in the standalone form or integrated into end devices, there is no reason to restrict MTE usage to specific network manager software. Generic SNMP based tools including the open source Net-SNMP can use an MTE module defined by the invention to access SNMPv1 MIBs securely through the tunnel of the invention. The DTE can also be integrated into NAT/Firewall boxes. The invention enables secure management and provides IP address multiplexing/hiding for SNMP. Integration into NAT/Firewall boxes allows secure management of network devices behind NAT/Firewall boundaries. The invention can also be applied to network request-response applications other than SNMP. The application interface provided by MTE and DTE to the SNMP PDU can be replaced by a layer that understands another request-response application while mapping to and from SNMP GETNEXT will remain unchanged. It will therefore be appreciated by those skilled in the art that yet other modifications could be made to the provided invention without deviating from its spirit and scope as claimed.

What is claimed is:

1. In a network including a network management station operably coupled to a first intermediate network interface, a network device operably coupled to a second intermediate network interface, and a communication network supporting communication between the first and second intermediate network interfaces, a method for communicating network management messages from the network management station to the network device comprising:
at the network management station, generating a first network management message intended for receipt at the network device;
receiving the first network management message at the first intermediate network interface;
in response to receiving the first network management message, generating a second network management message intended for receipt at the second intermediate network interface, the second network management message encapsulating information contained in the first network management message; and
sending the second network management message from the first intermediate network interface to the second intermediate network interface over the communication network, wherein
the first network management message comprises a request-type message and the second network management message comprises an SNMP message and the first network management message is encapsulated in at least part of a single variable binding of the SNMP message.

2. A method according to claim 1, wherein:
the first network management message comprises source address data corresponding to the network management station, destination address data corresponding to the network device, and application data; and
the second network management message comprises source address data corresponding to the address of the first intermediate network interface, destination address data corresponding to the address of the second intermediate network interface, and application data;
wherein the application data of the second network management message represents i) the source address data corresponding to the network management station as defined by the first network management message, ii) the destination address corresponding to the network device as defined by the first network management message, and iii) the application data of the first network management message.

3. A method according to claim 2, wherein:
the application data of the second network management message is represented in an encrypted form.

4. A method according to claim 2, wherein:
said variable binding includes a sequence ID and segmented application data.

5. A method according to claim 1, wherein:
the second network management message comprises an SNMP GET NEXT message.

6. A method according to claim 1, further comprising:
receiving the second network management message at the second intermediate network interface;
in response to receiving the second network management message at the second intermediate network interface, generating a third network management message intended for receipt at the network device, the third network management message including the information of the first network management message that was encapsulated in the second network management message; and
sending the third network management message to the network device.

7. A method according to claim 6, wherein:
the third network management message comprises the same information as the first network management message.

8. A method according to claim 2, further comprising:
associating the address data corresponding to the network device with the address data corresponding to the second intermediate network interface;
for each first management message, identifying the address of the second intermediate network interface which was associated with the destination address data corresponding to the network device; and
addressing the second management message to the address of the second intermediate network interface associated with the address data corresponding to the network device.

9. A method according to claim 6, further comprising:
at the network device, generating a fourth network management message in response to the third network management message, the fourth network management message intended for receipt at the network management station;
receiving the fourth network management message at the second intermediate network interface;
in response to receiving the fourth network management message, generating a fifth network management message intended for receipt at the first intermediate network interface, the fifth network management message encapsulating information contained in the fourth network management message; and
sending the fifth network management message to the first intermediate network interface over the communication network.

10. A method according to claim 9, wherein:
the fourth network management message comprises a response-type message and the fifth network management message comprises an SNMP message.

11. A method according to claim 9, wherein:
the fourth network management message comprises source address data corresponding to the network device, destination address data corresponding to the network management station, and application data; and
the fifth network management message comprises source address data corresponding to the second intermediate network interface, destination address data corresponding to the first intermediate network interface, and application data;
wherein the application data of the fifth network management message represents i) the source address data corresponding to the network device as defined by the fourth network management message, ii) the destination address corresponding to the network management station as defined by the fourth network management message, and iii) the application data of the fourth network management message.

12. A method according to claim 11, wherein:
the application data of the fifth network management message is represented in an encrypted form.

13. A method according to claim 11, wherein:
the fifth network management message comprises an SNMP message;
the fourth network management message is encapsulated in at least part of a single variable binding of the fifth network management message.

14. A method according to claim 13, wherein:
said variable binding of the fifth network management message includes a sequence ID and segmented application data.

15. A method according to claim 14, wherein:
the fifth network management message comprises a SNMP RESPONSE message.

16. A method according to claim 9, further comprising:
receiving the fifth network management message at the first intermediate network interface;
in response to receiving the fifth network management message at the first intermediate network interface, generating a sixth network management message intended for receipt at the network management station, the sixth network management message including the information of the fourth network management message which was encapsulated in the fifth network management message; and
sending the sixth network management message to the network management station.

17. A method according to claim 16, wherein:
the sixth network management message comprises the same information as the fourth network management message.

18. A method according to claim 9, further comprising:
associating address data corresponding to the first intermediate network interface with address data corresponding to the network management station;
receiving the fourth network management message at the second intermediate network interface;
for each fourth management message, identifying the address of the first intermediate network interface which was associated with the address data corresponding to the management station; and
addressing the fifth management message to the address of the first intermediate network interface associated with the address data corresponding to the network management station.

19. A method according to claim 16, further comprising:
at the network device, generating a seventh network management message intended for receipt at the network management station;
receiving the seventh network management message at the second intermediate network interface;
in response to receiving the seventh network management message at the second intermediate network interface, generating an eighth network management message intended for receipt at the first intermediate network interface, the eighth network management message encapsulating information contained in the seventh network management message; and
sending the eighth network management message to the first intermediate network interface over the communication network.

20. A method according to claim 19, wherein:
the seventh network management message comprises an unsolicited event or notification message and the eighth network management message comprises an SNMP message.

21. A method according to claim 19, wherein:
the seventh network management message comprises source address data corresponding to the network device, destination address data corresponding to the network management station, and application data; and
the eighth network management message comprises source address data corresponding to the second intermediate network interface, destination address data corresponding to the first network interface, and application data;
wherein the application data of the eighth network management message represents i) the source address data corresponding to the network device as defined by the seventh network management message, ii) the destination address corresponding to the network management station as defined by the seventh network management message, and iii) the application data of the seventh network management message.

22. A method according to claim 21, wherein:
the application data of the eighth network management message is represented in an encrypted form.

23. A method according to claim 22, wherein:
the eighth network management message comprises a SNMP message; and
the seventh network message is encapsulated in at least part of a single variable binding of the eighth network management message

24. A method according to claim 23, wherein:
the eighth network management message comprises a SNMP TRAP message, a notification-type message or an inform-type message.

25. A method according to claim 19, further comprising:
receiving the eighth network management message at the first intermediate network interface;
in response to receiving the eight network management message at the first intermediate network interface, generating a ninth network management message intended for receipt at the network management station, the ninth network management message including the information of the seventh network management message which was encapsulated in the eighth network management message; and
sending the ninth network management message to the network management station.

26. A method according to claim 25 wherein:
the ninth network management message comprises the same information as the seventh network management message.

27. A method according to claim 1, wherein:
the first intermediate network interface is part of a device separate and distinct from the network management station and coupled thereto over a communication link therebetween.

28. A method according to claim 1, wherein:
the second intermediate network interface is part of a device separate and distinct from the network device and coupled thereto over a communication link therebetween.

29. A method according to claim 1, wherein:
the first intermediate network interface is integral to the network management station.

30. A method according to claim 1, wherein:
the second intermediate network interface is integral to the network device.

31. A method according to claim 1, wherein:
the first intermediate network interface is coupled to a plurality of network management stations to support communication of the network management messages to and from said plurality of network management stations.

32. A method according to claim 1, wherein:
the second intermediate network interface is coupled to a plurality of network devices to support communication of the network management messages to and from said plurality of network devices.

33. An apparatus for tunneling legacy network management messages from management stations coupled to a first network through SNMP messages to legacy network devices coupled to a second network, said apparatus comprising:
a management tunnel endpoint coupled to said first network;
a device tunnel endpoint coupled to said second network;
a communications network coupled to said management tunnel endpoint and said device tunnel endpoint, said communications network capable of communicating SNMP messages between to said management tunnel endpoint and said device tunnel endpoint;
said management tunnel endpoint having means for receiving legacy management messages from the management stations, means for encapsulating legacy management messages in at least a portion of a variable binding of an SNMP message and means for transmitting the SNMP message to the device tunnel endpoint; and
said device tunnel endpoint having means for receiving SNMP messages from said management tunnel endpoint, means for decapsulating legacy management messages from a variable binding of an SNMP message, and means for transmitting legacy management messages to the legacy network devices.

34. An apparatus according to claim 33, wherein:
said device tunnel endpoint has means for receiving legacy management messages from the legacy network devices, means for encapsulating legacy management messages in at least a portion of a variable binding of an SNMP message and means for transmitting SNMP messages to the management tunnel endpoint;
said management tunnel endpoint having means for receiving SNMP messages from said device tunnel endpoint, means for decapsulating legacy management messages from a variable binding of an SNMP message, and means for transmitting legacy management messages to the legacy management stations.
